(19) United States
(12) Patent Application Publication
(10) Pub. No.: US 2025/0046844 A1
(43) Pub. Date: Feb. 6, 2025

(54) FABRICATION METHOD OF A MEMBRANE ELECTRODE ASSEMBLY (MEA), MEA, CELL AND USES THEREOF

(71) Applicant: FUNDACIÓ EURECAT, Cerdanyola del Valles, Barcelona (ES)

(72) Inventors: Claudia Custodia DELGADO SIMAO, Barcelona (ES); Thi Hai Van NGUYEN, Barcelona (ES); Diogo Miguel ESPERANÇA GARCIA, Barcelona (ES); Miguel BERENGUEL ALONSO, Barcelona (ES); Paul Dominique LACHARMOISE, Barcelona (ES)

(21) Appl. No.: 18/715,572

(22) PCT Filed: Dec. 1, 2022
(86) PCT No.: PCT/EP2022/084110

§ 371 Date: May 31, 2024

(30) Foreign Application Priority Data
Dec. 1, 2021 (EP) 21383086.2

(51) Int. Cl. H01M 8/1081; H01M 8/1004; H01M 8/1058

(52) U.S. Cl. CPC H01M 8/1081; H01M 8/1004; H01M 8/1058

(57) ABSTRACT

The present invention refers to fabrication method of a membrane electrode assembly (MEA), to MEA obtainable by said method, to a cell comprising said MEA, to the use of the MEA and the cell for the electrochemical detection of analytes, and to the use of the MEA and the cell for storing and/or delivering electricity.

### TECHNICAL FIELD

The present invention relates to the field of electrochemistry. More specifically, the present invention relates to the field of membrane electrode assembly (MEA) fabrication methods.

### BACKGROUND

Low-cost procedures and low environmental impact materials have been reported for the fabrication of membrane electrode assembly (MEA). Ink-jet and screen printing techniques have been used to fabricate parts of MEA.

Garcia et al. (ACS Omega 2019, 4, 16781-16788) studied the electrochemical properties of a capacitor printed on paper as an energy storage device, wherein a commercial paper sheet is both the substrate and the separator of the device. Zinc inks were applied on the surface of the paper substrate by bar coating and commercial silver inks were screen-printed on opposite sides of said paper substrate. Results showed the capacitor behaving as an energy storage device with a low current output. However, after the electrochemical processes, the initial flake-like shape of Zn particles was no longer observed, limiting the working lifetime of such device. Another drawback of said capacitor is that the silver particles used as electrode suffered oxidation in charging/discharging cycles of the battery.

M. Breitwieser et al. (Journal of Power Sources, Volume 337, 2017, Pages 137-144) described the fabrication of 12 microns thin proton-exchange membrane MEA by direct electrospinning poly(vinylidene fluoride-co-hexafluoropropylene) (PVDF-HFP) nanofibers onto commercial gas diffusion electrodes comprising a catalyst, followed by inkjet-printing a Nafion ionomer dispersion into the pore space of said fibers. This fabrication method is difficult to scale up due to the electrospinning step. In addition, using this fabrication method, only the thickness of the membrane of the MEA is reduced.

Therefore, despite the above-mentioned methods, it is desirable to develop new fabrication methods for MEA with increased efficiency and overall performance.

### BRIEF DESCRIPTION OF THE INVENTION

The authors of the present invention have developed a membrane electrode assembly (MEA) fabrication method wherein at least one diffusion layer of the MEA is obtained by an additive technique; and wherein the ion-exchange membrane is obtained by an additive technique. This method allows obtaining a MEA with a reduced thickness. This led to a reduction of the diffusion barrier while maintaining the mechanical robustness of said MEA. Moreover, the MEA obtained by said method shows a better performance over other MEA in the art with a fast membrane activation and similar range of current density generated. The method of the invention shows a particular impact as an industrial process, being able to be fully automatized and scalable. In addition, the method uses low-cost and sustainable materials, resulting in reducing costs of fabrication in at least one order of magnitude when compared to conventional MEA fabrication.

Thus, a first aspect of the invention is directed to a fabrication method for a membrane electrode assembly (MEA) comprising the following steps:
i. providing:
   an ion-exchange membrane with two opposite sides; and
   a first diffusion layer and a second diffusion layer comprising a carbon material with two opposite sides;
ii. coating:
   one side of the ion-exchange membrane and one side of one of the diffusion layers;
   two sides of the ion-exchange membrane; or
   one side of each of the diffusion layers;
   with a catalyst;
iii. placing the ion-exchange membrane between the first and the second diffusion layer; wherein both sides of the ion-exchange membrane are in contact with the catalyst; and
iv. optionally joining the first diffusion layer, the ion-exchange membrane and the second diffusion layer, under pressure and/or heat;
   wherein at least one of the diffusion layers and the ion-exchange membrane are obtained by an additive technique.

In a second aspect, the invention is directed to a membrane electrode assembly (MEA) obtainable by the method of fabrication as defined in any of the particular embodiments of the invention; wherein at least one of the diffusion layers has a thickness of below 30 microns; preferably wherein the at least one of the diffusion layers is a gas diffusion layer.

Another aspect is directed to a cell comprising a compartment comprising the membrane electrode assembly (MEA) as defined in any one of the embodiments of the invention, and means for connection with a power/load source.

An additional aspect is directed to the use of the membrane electrode assembly (MEA) as defined in any of the particular embodiments of the invention or the cell as defined in any of the particular embodiments of the invention for the electrochemical detection of analytes such as ferrocene.

A final aspect is directed to the use of the membrane electrode assembly (MEA) as defined in any of the particular embodiments of the invention or the cell as defined in any of the particular embodiments of the invention for storing and/or delivering energy; preferably electricity; preferably wherein the membrane electrode assembly (MEA) or the cell are part of a fuel cell.

### FIGURES

FIG. 1 shows an exploded view drawing of a MEA.

FIG. 2 shows a SEM micrograph of a MEA.

FIG. 3 shows the polarization curve result, this is, the cell potential (V) vs current density (mA·cm⁻²), for (a) a MEA comprising a paper-Nafion membrane and for (b) a MEA comprising a commercial Nafion membrane.

FIG. 4 shows the linear sweep voltammetry curve for different MEA.

FIG. 5 shows the results of dynamic mechanic analysis of a stress-strain experiment for different MEA.

FIG. 6 shows the results of contact angle test for different MEA.

FIG. 7 shows a Membrane electrode assembly (MEA) with screen-printed current collectors following a standard USB Series A Plug connector four pin/track design.

FIG. 8 shows a SEM micrograph of fully printed and conventional MEAs.

FIG. 9 shows the polarization curve for fully printed and conventional MEAs.

### DETAILED DESCRIPTION OF THE INVENTION

A first aspect of the invention is directed to a fabrication method of a membrane electrode assembly (MEA) comprising the following steps:
i. providing:
   an ion-exchange membrane with two opposite sides; and
   a first diffusion layer and a second diffusion layer comprising a carbon material, wherein each of the diffusion layers has two opposite sides;
ii. coating:
   one side of the ion-exchange membrane and one side of one of the diffusion layers;
   two sides of the ion-exchange membrane; or
   one side of each of the diffusion layers;
   with a catalyst;
iii. placing the ion-exchange membrane between the first and the second diffusion layer; wherein both sides of the ion-exchange membrane are in contact with the catalyst; and
iv. optionally joining the first diffusion layer, the ion-exchange membrane and the second diffusion layer; under pressure and/or heat;
   wherein at least one of the diffusion layers and the ion-exchange membrane are obtained by an additive technique.

In an embodiment, the fabrication method of a membrane electrode assembly (MEA) consists of the following steps:
i. providing:
   a ion-exchange membrane with two opposite sides; and
   a first diffusion layer and a second diffusion layer comprising a carbon material, wherein each of the diffusion layers has two opposite sides;
ii. coating:
   one side of the ion-exchange membrane and one side of one of the diffusion layers;
   two sides of the ion-exchange membrane; or
   one side of each of the diffusion layers;
   with a catalyst;
iii. placing the ion-exchange membrane between the first and the second diffusion layer; wherein both sides of the ion-exchange membrane are in contact with the catalyst; and
iv. optionally joining the first diffusion layer, the ion-exchange membrane and the second diffusion layer; preferably under pressure and/or heat;
   wherein at least one of the diffusion layers and the ion-exchange membrane are obtained by an additive technique.

In the context of the present invention the expression “additive technique” refers to a technique that allows either adding one layer or adding layer-upon-layer of a certain material. Non-limiting examples of additive techniques are serigraphy, screen-printing, flexography, bar-coating, inkjet printing, slot-die printing, spray coating, casting technique such as a tape-casting technique as for example a doctor blading technique; and mixed techniques thereof. In a particular embodiment, the additive technique of the present invention is selected from a screen-printing technique, a spray-coating technique, a casting technique or mixtures thereof.

In a particular embodiment, the screen-printing is performed by a pneumatic screen printer; preferably by a pneumatic flat screen printer.

In another particular embodiment, the casting technique is a tape-casting technique; preferably a doctor blading technique; more preferably a doctor blading technique performed by a blade.

In another particular embodiment, the spray-coating technique is performed by using pressurized gas such as air, preferably at a flow rate of between 1 and 1000 μl/min; preferably of between 100 and 800 μl/min; more preferably of between 200 and 700 μl/min. In a particular embodiment, the screen-printing technique was performed at a spray speed of between 500 and 3000 mm/min; preferably between 1000 and 2000 mm/min; more preferably between 1200 and 1800 mm/min.

### Step (i)

In an embodiment, the ion-exchange membrane is a proton exchange membrane.

In an embodiment, the ion-exchange membrane is obtained by a method comprising the steps of:
(a) depositing a composition comprising between 1 and 30 wt % of an ion-conducting polymer in a solvent or solvent mixture, on a substrate by an additive technique; and
(b) optionally, separating the deposited ion-exchange membrane from the substrate.

In a particular embodiment, the ion-exchange membrane is obtained by a tape-casting technique; preferably a doctor blading technique.

In an alternative particular embodiment, the additive technique is a screen-printing technique.

In an embodiment, the substrate is a cellulose-based substrate such as paper; preferably a paper sheet. In an embodiment, the cellulose-based substrate has been previously soaked in a composition comprising between 1 and 30 wt % of an ion conducting polymer in a solvent or solvent mixture.

In the context of the present invention, the term “ion-conducting polymer” refers to a polymer that shows electric conductivity due to the transport of ionic species. Non-limiting examples of ion-conducting polymers are sulfonated polyaniline or perfluorosulfonic acid (PFSA) polymer.

In an embodiment, the ion-conducting polymer is a fluorinated polymer; particularly a fluorinated polymer having sulfonic acid sites; preferably a sulfonated tetrafluoroethylene based fluoropolymer or a perfluorosulfonic acid (PFSA) polymer; more preferably is a tetrafluoroethylene-perfluoro-3,6-dioxa-4-methyl-7-octenesulfonic acid polymer or copolymer.

In another embodiment, the substrate is a glass sheet.

In a particular embodiment, the ion-exchange membrane comprises an ion-conducting polymer. In an embodiment, the ion-conducting polymer is an organic fluorinated polymer selected from homopolymers, copolymers, multicomponent polymers or combinations thereof. In a particular embodiment, the ion-conducting polymer is a fluorinated polymer; particularly a fluorinated polymer having sulfonic acid sites; preferably a sulfonated tetrafluoroethylene based fluoropolymer or a perfluorosulfonic acid (PFSA) polymer; more preferably is a tetrafluoroethylene-perfluoro-3,6-dioxa-4-methyl-7-octenesulfonic acid polymer or copolymer.

In an even more particular embodiment, the ion-exchange membrane comprises Nafion as commonly known in the art.

In a particular embodiment, the ion-exchange membrane further comprises a cellulose-based substrate; preferably a paper substrate; more preferably a paper sheet substrate; even more preferably a paper sheet having between 1 and 50 gsm; preferably between 2 and 30 gsm; more preferably between 5 and 25 gsm.

In a more particular embodiment, the ion exchange membrane consists of an ion-conducting polymer; preferably a fluorinated polymer; preferably a fluorinated polymer with sulfonic acid sites; more preferably a sulfonated tetrafluoroethylene based fluoropolymer or perfluorosulfonic acid (PFSA) polymer; even more preferably a tetrafluoroethylene-perfluoro-3,6-dioxa-4-methyl-7-octenesulfonic polymer or copolymer. In an even more particular embodiment, the proton exchange membrane consists of Nafion as known in the art.

In a particular embodiment, each of the sides of the ion-exchange membrane of the invention has an area of between 0.1 and 100000 cm²; preferably of between 0.5 and 100 cm²; more preferably of between 1 and 50 cm²; even more preferably of between 1 and 20 cm²; much more preferably of about 1, 2, 3, 4, 5, 6, 7, 8, 9 or 10 cm².

In a particular embodiment, the thickness of the ion exchange membrane of the invention is below 100 microns; preferably below 90 microns; more preferably below 70 microns; even more preferably below 50 microns.

In a particular embodiment, the thickness of the ion exchange membrane of the invention is between 1 and 200 microns; preferably between 2 and 100 microns; more preferably between 3 and 90 microns; even more preferably between 5 and 70 microns, even much more preferably between 6 and 50 microns.

In a more particular embodiment, the thickness of the ion exchange membrane is below 40 microns, preferably below 30 microns, more preferably below 20 microns, even more preferably below 15 microns; even much more preferably below 11 microns.

In a more particular embodiment, the thickness of the ion exchange membrane is between 1 and 30 microns, preferably between 2 and 20 microns, more preferably between 3 and 11 microns.

In an embodiment, the first diffusion layer and the second diffusion layer are gas diffusion layers (GDLs). Each of the diffusion layers comprises two opposite sides (for example, the diffusion layers have a planar shape).

In another embodiment, the first diffusion layer and/or the second diffusion layer comprise an electrically-conductive material. Non-limiting examples of electrically-conductive materials suitable for the diffusion layers are carbon-based materials such as carbon black, graphite or graphene; metallic materials such as metal particles; electrically conductive organic molecules such as electrically conductive polymers or mixtures thereof.

In a more particular embodiment, the first diffusion layer and/or the second diffusion layer comprise a electrically-conductive carbon-based material; preferably wherein the electrically-conductive carbon-based material is selected from carbon black, graphite, graphene or mixtures thereof; more preferably graphite.

In another more particular embodiment, the first diffusion layer and/or the second diffusion layer consist of a carbon-based material; preferably an electrically-conductive carbon-based material; more preferably wherein the electrically-conductive carbon-based material is selected from carbon black, graphite, graphene or mixtures thereof; even more preferably graphite.

In another embodiment, the first diffusion layer and/or the second diffusion layer are obtained by depositing an ink by an additive technique.

In another embodiment, the first diffusion layer and/or the second diffusion layer are obtained by screen-printing; preferably by screen printing an ink comprising a carbon-based material.

In a particular embodiment, the first diffusion layer and/or the second diffusion layer are obtained by a method comprising the steps of:
(a) depositing an ink comprising a carbon-based material, on a substrate by an additive technique, preferably by screen-printing; and
(b) optionally, separating the first diffusion layer and/or the second diffusion layer from the substrate.

In a more particular embodiment, the substrate is a cellulose-based substrate such as paper; preferably a paper sheet. In another embodiment, the substrate is a glass sheet; flexible inert polymer foil or a non-woven fabric.

In an embodiment, the ink comprises a carbon-based material. In a particular embodiment, the carbon-based material of the ink is an electrically-conductive carbon-based material; preferably selected from carbon black, graphite, graphene or mixtures thereof; more preferably graphite. In an embodiment, the ink comprises a solid content of between 10 and 90 wt % of the total weight of the ink; more preferably of between 20 and 80 wt %; even more preferably of between 30 and 70 wt %. In a more particular embodiment, the solids of the solid content of the ink consist of electrically-conductive carbon-based material particles, preferably selected from carbon black, graphite, graphene or mixtures thereof. In a particular embodiment, the particle size of the solids of the ink is in preferably between 1 nm and 20 micrometers; preferably between 2 nm and 18 micrometers; more preferably between 5 nm and 15 micrometers.

In a more particular embodiment, the ink has a viscosity between 100 and 1000 Pas measured by a rheometer technique, preferably at a temperature of about 25° C.

In a particular embodiment, the sides of the first diffusion layer and/or the second diffusion layer of the invention have an area of between 0.1 and 100000 cm²; preferably of between 0.5 and 100 cm²; more preferably of between 1 and 50 cm²; even more preferably of between 1 and 20 cm²; much more preferably of about 1, 2, 3, 4, 5, 6, 7, 8, 9 or 10 cm²; even much more preferably of about 3 or 4 cm².

In a particular embodiment, the thickness of the first diffusion layer and/or the second diffusion layer of the invention is below 30 microns; preferably below 20 microns; more preferably below 12 microns; even more preferably below 11, 10, 9, 8, 7 or 6 microns.

In a particular embodiment, the thickness of the ion exchange membrane of the invention is between 1 and 60 microns; preferably between 2 and 20 microns; more preferably between 3 and 16 microns.

In a particular embodiment, the first diffusion layer and/or the second diffusion layer comprise pores such as macro-pores; preferably they comprise slits. In an embodiment, the pores have an area of between 1 and 10% of the total area of the diffusion layer; preferably of between 6 and 9%.

### Step (ii)

In a particular embodiment, step (ii) comprises coating the two sides of the proton-exchange membrane with a catalyst.

In a particular embodiment, step (ii) comprises coating one side of each of the diffusion layers with a catalyst.

In an embodiment, the coating of step (ii) is performed by spray coating.

In a more particular embodiment, the catalyst is coated by spray coating a composition comprising (i) between 0.1 and 10 wt % of catalyst of the total weight of the composition,
and (ii) a solvent or a solvent mixture; preferably between 0.5 and 6 wt % of catalyst; more preferably between 1 and 5 wt %.

In an embodiment, the composition further comprises a polymer; preferably an ion-conducting polymer; more preferably a fluorinated polymer.

In a more particular embodiment, the solvent or solvent mixture of the composition comprises polar solvents; preferably comprises water; more preferably consists of a mixture of water and an organic alcohol.

In an embodiment, the catalyst is selected from a metal, a metal oxide, an organometallic compound, a polymer, a biomolecule or mixtures thereof.

In an embodiment, the catalyst comprises a metal element. In an embodiment, the metal element of the catalyst is selected from Ag, Pt, Ru, Ni, Co, Cu, Zn, Au, Ir, Fe, Mn, W, Mo, Pd, In, Rh, Re, Sn, La or mixtures thereof; preferably Ag, Pt, Ru and mixtures thereof.

In a particular embodiment, the catalyst comprises a metal, a metal oxide or a mixture thereof. In a more particular embodiment, the catalyst comprises a metal deposited on a carbon substrate.

In another particular embodiment, the catalyst consists of a metal, a metal oxide or a mixture thereof. In a more particular embodiment the catalyst consists of a metal deposited on a carbon substrate.

In a particular embodiment, the catalyst is coating
one side of the ion-exchange membrane and one side of one of the diffusion layers;
two sides of the ion-exchange membrane; or
one side of each of the diffusion layers;
in an amount of between 0.01 and 10 mg/cm²; preferably of between 0.1 and 9 mg/cm²; more preferably of between 0.5 and 6 mg/cm²; even more preferably of between 0.8 and 3 mg/cm²; even much more preferably in an amount of about 1, 1.5, 2 or 2.5 mg/cm².

The authors have observed that spray-coating the catalyst has the advantage of good control of the amount of the catalyst used and of the coating homogeneity. This technique also allows a great control of the roughness of the catalyst, thus, improving the contact between the membrane and the catalysts.

Step (iii)

The method of the invention has a step (iii) of placing the ion-exchange membrane between the first and the second diffusion layer; wherein both sides of the ion-exchange membrane are in contact with the catalyst.

If the two sides of the ion-exchange membrane are coated with the catalyst, step (iii) comprises depositing one or the two diffusion layers by an additive technique on one or on the two opposite sides of the ion-exchange membrane; particularly, depositing a diffusion layer on each side of the ion-exchange membrane.

If one side of a diffusion layer is coated with the catalyst; step (iii) may be performed by:
(a) depositing, on the catalyst-coated side of the diffusion layer, a ion-exchange membrane; preferably by an additive technique such as screen-printing; and
(b) depositing another diffusion layer on top of the ion-exchange membrane; optionally preferably by an additive technique such as screen-printing.

In a particular embodiment, one side of the ion-exchange membrane or one side of the diffusion layer is coated with catalyst so both sides of the ion-exchange membrane are in contact with the catalyst.

In a more particular embodiment, the first diffusion layer and the second diffusion layer are obtained by an additive technique such as screen-printing.

### Step (iv)

Step (iv) of the method of the present invention is directed to optionally joining the first diffusion layer, the ion-exchange membrane and the second diffusion layer; under pressure and/or heat.

Step (iv) of the method of the invention may be performed by any technique known in the art; preferably under pressure and heat.

In a particular embodiment, the temperature is between 90 and 150° C.; preferably between 100 and 140° C.; even much more preferably about 130° C.

In a particular embodiment, the pressure is between 0.1 and 1 tons; preferably between 0.2 and 0.8 tons; even much more preferably about 0.5 tons.

In the method of the present invention, the ion-exchange membrane is obtained by a casting technique or by a screen-printing technique; and at least one diffusion layer is obtained by an additive technique. In a particular embodiment, the two diffusion layers are obtained by an additive technique.

In an embodiment, the ion-exchange membrane is obtained by a method comprising the steps of: (a) depositing a composition comprising between 1 and 30 wt % of an ion-conducting polymer in a solvent or solvent mixture on a substrate; and (b) optionally separating the deposited ion-exchange membrane from the substrate; preferably wherein the ion-conducting polymer is a fluorinated polymer.

In a particular embodiment, the composition has between 1 and 30 wt % of a fluorinated polymer of the total weight of the composition; preferably the composition has between 2 and 28 wt %; more preferably the composition has between 3 and 24 wt %; even much more preferably the composition has about 5 wt %, 10 wt %, 15 wt % or 20 wt % of fluorinate polymer.

In a more particular embodiment, the solvent or solvent mixture comprises polar solvents; preferably comprises water; more preferably consist of a mixture of water and an organic alcohol such as ethanol, propanol, derivatives and mixtures thereof.

In an embodiment, the ion-exchange membrane is obtained by a method comprising the steps of: (a) depositing a composition comprising between 1 and 30 wt % of a fluorinated polymer in a solvent or solvent mixture on a substrate, wherein the substrate is a cellulose substrate such as a paper sheet; preferably the deposition is performed by tape-casting technique or drop casting; preferably by doctor blading.

In an embodiment, the substrate of step (a) is a cellulose substrate which has been obtained by soaking the cellulose substrate in a composition comprising between 0.5 and 50 wt % of a fluorinated polymer in a solvent or solvent mixture. In a particular embodiment, the fluorinated polymer was at between 1 and 30 wt %; preferably at between 10 and 25 wt % in the composition; more preferably at between 15 and 22 wt %; more preferably at about 20 wt %. In a more particular embodiment, the soaking step is performed under mechanical mixing; preferably under ultrasonic mixing.

In a more particular embodiment, the ion-exchange membrane is obtained by a method comprising the steps of: (a) depositing a composition comprising between 1 and 30 wt % of a fluorinated polymer in a solvent or solvent mixture on a substrate; and (b) separating the deposited ion-exchange membrane from the substrate; wherein the deposition is performed by tape-casting technique; preferably by doctor blading and optionally, wherein the substrate is a glass substrate; preferably a glass slide.

In the context of the present invention the expression “doctor blading or doctor blade” refers to the technique commonly understood in the art, a coating technique performed by placing a sharp blade at fixed distance from the surface to cover, the coating composition is then placed in front of the blade and the blade is moved across in-line with the surface, creating a film or layer on said surface.

In a particular embodiment, the deposition is performed preferably by applying between 1 and 20 layers by doctor blading; preferably by applying between 2 and 10 layers.

In a particular embodiment, the deposited ion-exchange membrane is separated from the substrate by adding water and waiting at least 10 min, for the membrane to detach from the surface; preferably at least 1 hour, more preferably at least 4 hours; even more preferably between 5 to 10 hours.

In a more particular embodiment, the ion-exchange membrane is pressed; preferably hot-pressed; more preferably hot-pressed at between 4° and 100° C.; more preferably at between 6° and 90° C.; even much more preferably at about 80° C. The authors have observed that by pressing the ion-exchange membrane, the excess of solvents are removed and the ion-exchange membrane is flattened.

### Membrane Electrode Assembly (MEA)

An aspect of the invention is directed to a membrane electrode assembly (MEA) obtainable by the method of fabrication as defined in any of the particular embodiments of the invention.

Any of the characteristics described above for the ion-exchange membrane, the first diffusion layer, the second diffusion layer or the catalyst in any of the particular embodiments of the method might apply to the ion-exchange membrane, the first diffusion layer, the second diffusion layer or the catalysts of the membrane electrode assembly (MEA) described herein.

In an embodiment, the membrane electrode assembly (MEA) has a thickness of below 250 microns; preferably of below 200 microns, more preferably below 100 microns; even more preferably of below 60 microns; even much more preferably of below 55 microns.

### Cell

Another aspect of the present invention is directed to a cell comprising
a compartment comprising
   the membrane electrode assembly (MEA) as defined in any of the particular embodiments of the invention, and
   means for connecting with a power/load source.

In an embodiment, the means for connecting with a power/load source are means for electrical connecting with a power/load source and may be any means known in the art such as electric wires. In a particular embodiment, the means for connecting are able to electrically connect the MEA, and/or the current collectors with the power/load source.

In a particular embodiment, the cell further comprises a power/load source.

The power/load source may be any external electrical device such as an electrical grid, an electric vehicle, a domestic appliance or a sensor, that draws/transfers energy from/to the battery. In general, the power/load source has controllable voltages and/or current supplies or uptakes.

In a particular embodiment, the cell further comprises current collectors. In an embodiment, the MEA is sandwiched between the current collectors. In an embodiment, the current collectors comprise metal particles; preferably silver particles.

In a particular embodiment, the current collectors have a final thickness of at least 1 micron; preferably at least 2 microns; more preferably between 5 and 15 microns.

In a more particular embodiment, the current collectors of the cell are obtained by depositing a composition comprising metal particles in a solvent or solvent mixture; preferably by depositing silver particles in a solvent or solvent mixture.

In a more particular embodiment, the current collectors of the cell are obtained by screen printing.

In a more particular embodiment, each of the current collectors coats one side of the two MEA sides (i.e. the current collectors have an area that matches the printed MEA area) and optionally the current collectors comprise means for connecting; preferably a connector having a standard USB Series A Plug connector four pin/track design. In a particular embodiment, the connector has been screen-printed.

In an embodiment, the current collectors are in contact with the surface of each of the diffusion layers of the MEA.

In an embodiment, the cell comprises at least one dielectric layer; preferably wherein the at least one dielectric layers is in contact with the surface of a current collector. In a particular embodiment, the at least one dielectric layer comprises a polymer, preferably an acrylic polymer. In a more particular embodiment, the cell comprises at least two dielectric layers one on each side of the MEA, in contact with the current collector.

The cell of the present invention may comprise an external case.

### Uses

An additional aspect is directed to the use of the membrane electrode assembly (MEA) as defined in any of the particular embodiments of the invention or the cell as defined in any of the particular embodiments of the invention, for the electrochemical detection of analytes; preferably by amperometric or potentiometric methods.

An aspect of the invention is directed to a method for the electrochemical detection of an analyte comprising using the membrane electrode assembly (MEA) of the invention as defined in any of the particular embodiments or the cell as defined in any of the particular embodiments of the invention; preferably by amperometric or potentiometric methods.

A final aspect is directed to the use of the membrane electrode assembly (MEA) as defined in any of the particular embodiments of the invention or the cell as defined in any of the particular embodiments of the invention, for storing and/or delivering energy; preferably electricity; preferably wherein the membrane electrode assembly (MEA) or the cell are part of a fuel cell.

An aspect of the invention is directed to a method for storing and/or delivering energy, preferably electricity comprising using the MEA or the cell of the invention as defined in any of the particular embodiments; preferably wherein the MEA or the cell are part of a fuel cell.

It should be understood that the scope of the present disclosure includes all the possible combinations of embodiments disclosed herein.

### EXAMPLES

The present invention will be described in further detail with reference to the following examples. These examples are for illustrative purposes only and are not intended to limit the scope of the present invention.

### Example 1: Membrane Electrode Assembly (MEA) with Screen-Printed Gas-Diffusion Layers (GDL)

A catalyst ink was prepared by mixing water, isopropanol and a commercial Nafion®117 composition (wherein Nafion is at a 5 wt % in a mixture of low aliphatic alcohols and water) with a 3 wt % catalyst. The catalyst used was Pt/C catalyst powder (from Merk), PtB (Platinum Black) or RuO₂ particles (from Thermo fisher). The ink was sonicated (Ultrasons Selecta 3000683, 50/60 kHz, 110 W) during 30 min. Nafion is understood as the generic name for a sulfonated tetrafluoroethylene-based fluoropolymer-copolymer.

A membrane electrode assembly (MEA) was prepared by a catalyst-coated membrane (CCM) method: First, an electrode (anode and/or cathode) was prepared by depositing the ink described above using spray deposition (spray nozzle 2W, catalyst ink flow rate 300 μl/min, air pressure 130 mbar, spray speed 1500 mm/min) on one or on the two opposite sides of a Nafion® 212 commercial proton-exchange membrane (NR-212 membrane of Tetrafluoroethylene-perfluoro-3,6-dioxa-4-methyl-7-octenesulfonic acid with about 51 microns of thickness) to create a catalyst coated membrane (CCM) leading to a nanoparticle concentration in each side of about 1 mg/cm² of Pt (cathode side) and of about 2 mg/cm² for RuO₂ (anode side).

Each side of the catalyst coated membrane was subsequently coated by a gas-diffusion layer (GDL) by screen-printing using a carbon paste purchased from Carbon Creative or Sun Chemical (Ref. C2030519P4, having a solids content of 39.0-43.0% at 130° C.). The GDL was printed with a medium sized pneumatic flat screen printer from ATMA (model AT-60FA) followed by a thermal curing at 130° C. (15 min) on a UN160 lab oven from Memmert. Results showed that the carbon layers printed from Carbon Creative (Ref.: 122-49) and Graphite Sunchemical inks had thicknesses of between 10-14 and 7-18 μm, respectively.

A silver nanoparticle ink was then screen-printed on top of each GDL as current collector. The ink was purchase from DuPont (Ref. 5000, having a solids content 58-62%). The current collectors were printed with a medium sized pneumatic flat screen printer from ATMA (model AT-60FA) followed by a thermal curing at 130° C. (10 min) on a UN160 lab oven from Memmert.

Alternatively, a membrane electrode assembly (MEA) was prepared by a catalyst-coated substrate (CCS) method: firstly, a GDL was screen-printed as described above. Then, the catalyst ink described above was deposited on one side of the GDL. A Nafion membrane was added on top of the catalyst-coated GDL. Then, another GDL coated with catalyst was deposited on top of the Nafion membrane (with the catalyst contacting the Nafion membrane). A silver nanoparticle ink was then screen-printed on top of each GDL as current collector.

When, the catalyst was deposited by spray deposition, the average roughness Ra of the surface were measured and the result showed that spray coating the catalyst had the advantage of good control of the average roughness of the coated surface. The Average Roughness (the arithmetic average deviation from the mean line within the assessed profile) measurements were done using a Dektak 150 Surface Profilometer. For example, the average roughness of a GDLs coated with a catalyst was ranging from 950 to 1200 nm.

In addition, results showed that GDLs with a significantly smaller thickness than the commercial ones were prepared with the method described above. The conductivity of GDLs, synthetized as described above, was tested against their thickness using a four-Point Probe system four. In particular, equally spaced and co-linear probes were used to make electrical contact with the material to be characterized as known in the art. The thickness of the GDL was measured by a profilometry technique. GDL Results showed that the highest conductivity values were obtained when the thickness of the catalyst-deposited GDL was about 8.4 microns for Sun Chemical GDL and about 15.3 microns for Carbon Creative GDL. Moreover, results showed that an increase in the GDL thickness led to a decrease of their conductivity. In addition, the best conductivity results were obtained for SunChemical GDL.

The stability of catalyst deposited GDL was also tested at different pH and temperatures. Screen-printed GDL layers showed an easy manipulation, homogeneous surface and high conductivity when compared to conventional GDL.

Optionally, a dielectric ink purchased form Sun Chemical (Ref. suntronic 681, acrylate based ink) was screen-printed on top of each side of any of the MEAs described above with a medium sized pneumatic flat screen printer from ATMA (model AT-60FA) followed by a UV curing with UV lamp (model HOC-35/1-200/BE OBC from B.C.B.) to encapsulate the whole device area.

When both GDL are screen-printed there is no need of an additional joining step under pressure and/or heat. Moreover, it has been observed that MEA with screen-printed GLD have better adhesion between the layers of the MEAs and thus, better charge transfer. In addition, the manufacturing process is simplified.

In the case where one of the GDL is commercial one an additional joining step was performed. In particular, hot pressing at the following conditions: 130° C., 15 minutes under 0.5 tons using the hot press machine CARVER Model 4386 Bench Top Laboratory Manual Press with Electrically Heated Platens.

### Example 2: Membrane Electrode Assembly (MEA) with a Membrane Synthesized by Doctor Blading Technique

MEA were prepared following Example 1 but wherein the membrane was prepared as follows:

A Nafion perfluorinated resin composition 5 wt. % in lower aliphatic alcohols and water was deposited by Doctor Blading technique on a glass slide. Doctor blade coating or doctor blading is a technique used to form films with well-defined thicknesses. The technique works by placing a sharp blade at fixed distance from the surface that needs to be covered. The coating composition is then placed in front of the blade and the blade is moved across in-line with the surface, creating a layer or ultrathin membrane film.

The membrane was delaminated from the glass slide substrate by adding water, and letting the membrane detach from the glass substrate overnight. The thickness of the Nafion membrane was between 1 and 7 microns for between 2 and 10 layers applied by Doctor Blade technique.

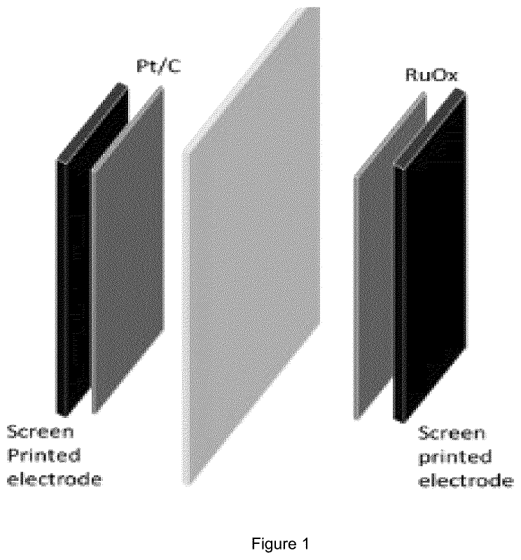

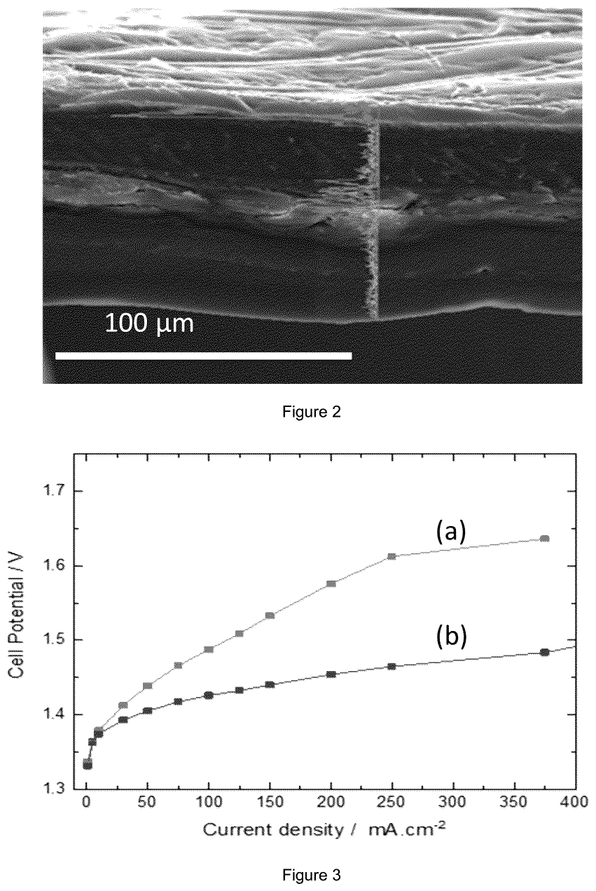

FIG. 1 shows an exploded view drawing of a MEA. FIG. 2 shows a SEM micrograph of a MEA with a screen-printed Nafion membrane.

### Example 3: Membrane Electrode Assembly (MEA) with a Paper-Nafion Membrane

A MEA was prepared following Example 1 but wherein the membrane was prepared as follows:

First, a 3 cm×3 cm pieced of paper (LEINE SILK 20 gsm (grams per square meter) paper from SAPPI) was immersed in a Nafion composition wherein the Nafion is in a 20 wt % over the total weight of the composition in lower aliphatic alcohols and water, and sonicated in a Elmasonic S100H for 30 minutes in a closed jar. Then, 200 μl of the Nafion composition was deposited on top of the paper by doctor blade method.

The membrane was air dried overnight before being hot-pressed at 80° C. (CARVER PRESS, 0.2 metric tons), for 5 minutes to remove excess solvents and flatten the SAPPI/Nafion membrane before use. The proton-exchange membrane obtained by this method has an amount of Nafion of about 50% in weight of the total weight of the membrane. An advantage of the previously described method is that the thickness of the proton-exchange membrane obtained by it may be reduced by reducing the amount of Nafion deposited on the paper.

FIG. 3 shows the polarization curve for (a) a MEA comprising a paper-Nafion membrane prepared according to the present example and for (b) MEA comprising a commercial Nafion membrane (Nafion 212 membrane) prepared according to Example 1. Both MEA show good performance. The MEA comprising a paper-Nafion membrane shows higher current density, when compared with similar MEA comprising a commercial membrane.

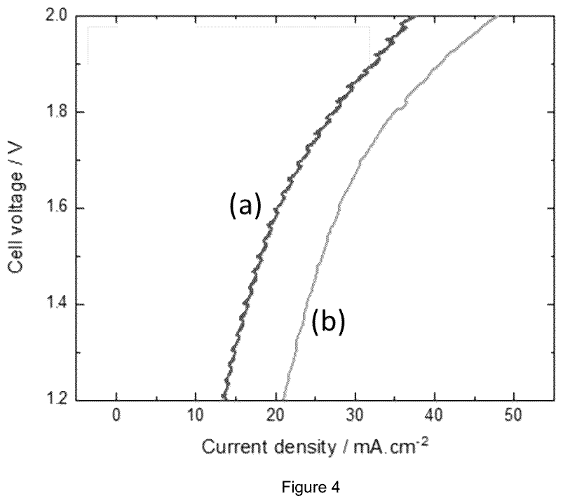

In addition, paper-Nafion membranes were used to prepare MEAs following the CCM and the CCS methods described on Example 1. The MEAs were electrochemically tested. FIG. 4 shows the results of cell potential (V) vs current density (mA·cm⁻²) for a MEA comprising a paper-Nafion membrane (a) obtained by a CCM method and (b) obtained by a CCS method. Both MEA show good performance. However, the MEA comprising a paper-Nafion membrane obtained by a CCM method shows higher potential values than the one obtained by a CCS method.

The properties of a commercial Nafion membrane (Nafion® 212 commercial proton-exchange membrane), a paper membrane (SAPPI LEINE SILK 20 gsm paper) and a paper-Nafion membrane synthesized as described above, were compared by contact angle tests, the measurement of stress-strain curves and thermogravimetric analysis (results not showed herein).

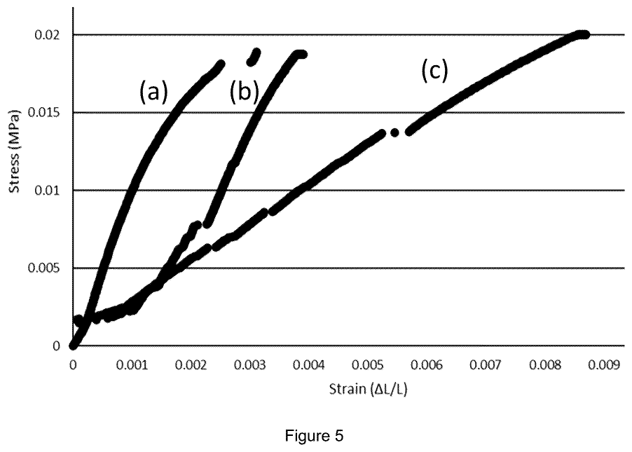

FIG. 5 shows the results of dynamic mechanic analysis of a stress-strain experiment of (a) paper membrane, (b) Nafion-paper membrane and (c) a bulk Nafion 212 membrane. At strains below 0.2% the curve of the paper-Nafion membrane matches the one of the bulk Nafion membrane and at strains over 0.2%, the Nafion-paper membrane shows a slope similar to paper.

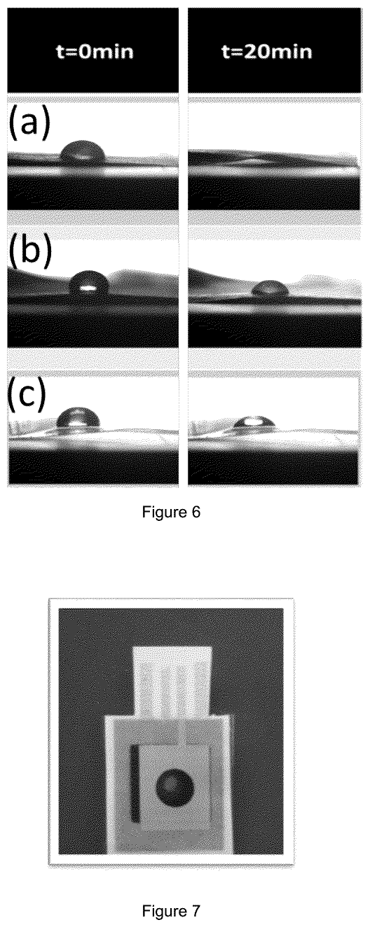

FIG. 6 shows the results of contact angle test for (a) paper membrane, (b) Nafion-paper membrane and (c) a bulk Nafion membrane. Particularly, the paper-Nafion membrane can maintain its shape after being in contact with a water droplet for at least 20 min while the paper membrane absorbs water and the Nafion membrane is deformed. In addition, the paper-Nafion membrane mechanical properties are a combination of the mechanical properties of the bulk Nafion and of the paper substrate.

Thermogravimetric analysis results for paper, Nafion-paper and Nafion membranes confirm that the Nafion-paper membrane shows a mixture of Nafion and paper properties.

### Example 4: Membrane Electrode Assembly (MEA) with a Spraycoated Membrane

MEA were prepared following Example 1, 2 or 3 but by adding the Nafion membrane by a spray-coating technique. The proton-exchange membrane obtained by printing has a thickness of approximately 30 microns. An advantage of this spray method is that the thickness of the proton-exchange membrane obtained by it may be reduced by reducing the amount of Nafion deposited by spray-coating.

### Example 5: Membrane Electrode Assembly (MEA) with a Screenprinted Electrode

MEA were prepared following Example 1, 2, 3 or 4 but by adding the catalyst by an screen-printing technique.

### Example 6: Membrane Electrode Assembly (MEA) with Different Gas-Diffusion Layer (GDL) Shapes

Different MEA were prepared following Example 1, 2, 3 or 4 but modifying the shape of the gas discussion layers (GDL). The GDL had a 2×2 cm² working area with a 2.25×0.5 cm² connector.

In addition, different working areas and porosities were studied: having a 4 cm² area and no macro-pores (namely bulk (B)) and having 3 cm² working area with squared and rectangular macro-pores shaped as windows (W) and slits (S). The pore area was between 1 mm² and 50 mm². The number of pores also varied between 1 to 100.

Results showed that the MEAS comprising GDL with an area of 3 cm² and with macro-pores, did not present performance losses in terms of current density when compared to those having GDL with areas of 4 cm² and no pores.

In addition, results showed that the GDL having a 3 cm² working area and with 25 mm² rectangular macro-pores shaped as slits (S) presented the higher performance.

### Example 7: MEA Characterization

The MEA, prepared by any of the Examples described above, were characterized by the following techniques:

Thermogravimetric Analysis (TGA) was done on a TGA/DSC METTLER TOLEDO STAR system from JULABO Labortecknik GmbH. Samples were dried in an oven at 80° C. prior to analysis. TGA test were performed with approximately 15 mg of the sample under nitrogen gas and at a temperature ramp of about 10° C. min⁻¹.

Infrared spectra were recorded using PerkinElmer Spectrum 100 FT-IR spectrometer scanning in the region ranging from 4000 to 750.

The morphologies of the MEA were investigated by the FEI Quanta 650 FEG Field Emission scanning electron microscope (ESEM). The sample preparation was done as follows: For cross section, the samples were prepared by cutting with a razor blade at ambient temperature. No liquid nitrogen was used. The samples were then mounted on a cross sectional specimen holder in a Quanta 650 FEG ESEM was operated in low vacuum mode and using the backscattered electrons detector. For top view, the samples were stick with Carbon tape and placed on an Aluminum stub. The samples were then mounted in a Quanta 650 FEG ESEM and as the sample surface is conductive the SEM was operated in high vacuum mode using the secondary electrons detector and the backscattered electrons detector when needed.

Electrochemical tests were performed using a PGSTAT204 potentiostat/galvanostat from Metrohm Autolab B.V equipped with a frequency response analyzer (FRA) and a 10 A booster (BSTR10A) module. Linear Sweep voltammetry and Cyclic voltammetry (CV) were performed at 50 mV s⁻¹. Electrochemical impedance spectroscopy (EIS) measurements were performed with a potential perturbation of 10 mV·rms. The frequency range was 10 mHz⁻¹ MHz.

Water contact angle studies were done using KRUSS DSA E20 contact angle goniometer materials using the sessile droplet method.

Results showed that the reduced thickness of the MEA of the examples lead to a reduction of the diffusion barrier and to better performance over commercial MEA having between 300 and 800 microns in total. This is particularly remarkable in the MEA obtained in Examples 2, 3 and 4. In addition, paper-Nafion membrane and screen-printed membranes have additional advantages such as: reducing the amount of Nafion used, increasing water diffusion, and reducing conditioning time of the membrane, thus increasing the performance of the MEA.

### Example 8: Membrane Electrode Assembly (MEA) with Screen-Printed Current Collectors Following a Standard USB Series a Plug Connector Four Pin/Track Design

MEA were prepared following Example 1, 2, 3, 4, 5 or 6 but including an screen-printed current collector layer that was printed (i) coating the MEA sides and (ii) also creating a connection that is printed following a standard USB Series A Plug connector four pin/track design as known in the art (see FIG. 7).

### Example 9: Electrochemical Detection of Ferrocene Using the Membrane Electrode Assembly (MEA)

An experiment electrochemical detection of ferrocene is done using the Membrane electrode assembly (MEA) of the invention as described in any of the previous experiments using cyclic voltammetry technique. In the set-up the MEA is connected to a potentiostat. In addition, the MEA may need to be pre-wet. Then, a drop of the sample that might comprise the analyte to be detected is inserted by drop-casting on the working area of the MEA and the cyclic voltammetry technique is performed. Results obtained are compared with results previously obtained for different concentration of the analyte (i.e. ferrocene) and the presence or absence of the analyte is decided.

### Comparative Example 10: Conventional Membrane Electrode Assembly (MEA)

A catalyst ink was prepared by mixing water, isorpropanol and Nafion® (wherein Nafion® is a 5 wt % Nafion® perfluorinated resin solution in low aliphatic alcohols and water) and catalyst. The catalyst used was Pt/C catalyst powder for the cathode or RuO₂ particles for the anode. The ink was sonicated (Elmasonic S100H) for at least 1 h before use.

An electrode (anode and/or cathode) was prepared by depositing the ink described above using an automated ultrasonic spray apparatus (spray nozzle AccuMist, catalyst ink flow rate 300 μl/min, air pressure 100 mbar, spray speed 2500 mm/min directly onto carbon GDL (carbon paper H23C2 GDL). A Nafion® 212 commercial proton-exchange membrane (Nafion® 212 commercial proton-exchange membrane with about 40 to 60 microns of thickness was added on top of the catalyst-coated GDL. Then, another GDL (carbon paper H23C2 GDL) coated with catalyst was deposited on top of the Nafion membrane (with the catalyst contacting the Nafion membrane) leading to a nanoparticle concentration in each side of about 1 mg/cm² of Pt (cathode side) and of about 2 mg/cm² for RuO₂ (anode side). Finally, Ti foil external current collectors pressed on top of the carbon GDLs were required to achieve a functional MEA.

Employed reagents and amount of materials, as well as thickness of each layer of the MEA obtained are shown in Table 1. For comparative purposes, a fully printed MEA prepared according to the examples of the invention (both GDL electrodes and current collectors obtained by screen-printing) prepared with the conventional Nafion® 212 commercial proton-exchange membrane, is also shown in Table 1.

TABLE 1
Comparison of thickness and weight
of different MEA configurations.

| | Conventional MEA | | | |
|---|---|---|---|---|
| | (comparative example 1) | | Fully printed MEA | |
| | (4 cm² active area) | | (4 cm² active area) | |
| | Thickness | Weight | Thickness | Weight |
| MEA layer | (μm) | (mg) | (μm) | (mg) |
| Cathode Current | 890 | 5000-7000 | 5-15 | 25-75 |
| collector | (Ti foil) | | | |
| Cathode GDL | 255 | 110-130 | 5-20 | 15-30 |
| | (H23C2 GDL) | | | |
| Cathode catalyst | 5-20 | 5-20 | 5-20 | 5-20 |
| Membrane | 51 | 50 | 51 | 50 |
| | (Nafion 212 | (Nafion | (Nafion | (Nafion |
| | PEM) | 212) | 212) | 212) |
| Anode catalyst | 5-20 | 20-22 | 5-50 | 20-22 |
| Anode GDL | 255 | 110-130 | 5-20 | 15-30 |
| | (H23C2 GDL) | | | |
| Anode current | 890 | 5000-7000 | 5-15 | 25-75 |
| collector | (Ti foil) | | | |
| Total | 2330 | 10300-14400 | 80-200 | 150-300 |

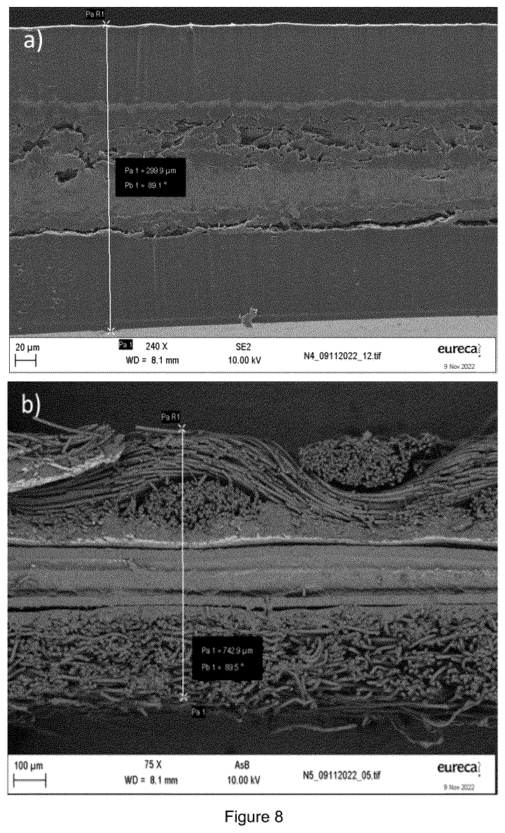

Results show a reduction in thickness and amount of materials for the fully printed MEA. As it can be seen from Table 1, a considerable reduction in current collectors and GDL layers was achieved with the fully printed MEA of the invention. FIG. 8 provides scanning electron microscopy (SEM) images showing the total thickness for (a) a fully printed MEA total thickness and (b) a conventional MEA. Remarkably, the fully printed MEA of the invention with printed metal current collectors exhibits a thickness approximatively 65 times thinner than the MEA obtained by a conventional approach with external Ti foil current collectors.

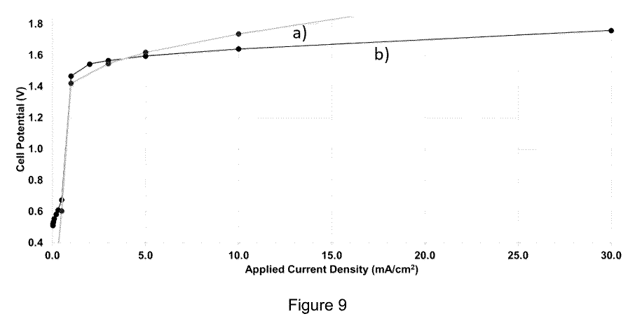

Furthermore, results showed that the fully printed MEA of the invention lead to a performance comparable to that of a conventional MEA. FIG. 9 shows the polarization curve result for (a) a fully printed MEA and (b) a conventional MEA prepared according to comparative example 10. Both MEA show good performance.

The inventors surprisingly found that the reduced thickness of the fully printed MEA of the present invention actively contributes to an improvement in the contact of interlayer interfaces, leading to a good performance of fully printed MEA using a considerably lower amount of materials.

1.-15. (canceled)

16. A fabrication method for a membrane electrode assembly (MEA) comprising the following steps:
i. providing:
an ion-exchange membrane with two opposite sides; and
a first diffusion layer and a second diffusion layer comprising a carbon material, wherein each of the diffusion layers has two opposite sides;
ii. coating:
one side of the ion-exchange membrane and one side of one of the diffusion layers;
two sides of the ion-exchange membrane; or
one side of each of the diffusion layers;
with a catalyst;
iii. placing the ion-exchange membrane between the first and the second diffusion layer; wherein both sides of the ion-exchange membrane are in contact with the catalyst; and
iv. optionally joining the first diffusion layer, the ion-exchange membrane and the second diffusion layer; under pressure and/or heat;
wherein at least one of the diffusion layers and the ion-exchange membrane are obtained by an additive technique.

17. A fabrication method according to claim 16, wherein the ion-exchange membrane is a proton-exchange membrane obtained by a method comprising the steps of: (a) depositing a composition comprising between 1 and 30 wt % of a fluorinated polymer in a solvent or solvent mixture, on a substrate by an additive technique; and (b) optionally, separating the deposited proton-exchange membrane from the substrate.

18. A fabrication method according to claim 17, wherein the substrate is a cellulose-based substrate.

19. A fabrication method according to claim 18, wherein the cellulose-based substrate is previously soaked in a composition comprising between 1 and 30 wt % of a fluorinated polymer in a solvent or solvent mixture.

20. A fabrication method according to claim 17, wherein the deposition of step (a) is performed by a tape-casting technique.

21. A fabrication method according to claim 20, wherein the tape-casting technique is doctor blading technique.

22. A fabrication method according to claim 16, wherein the diffusion layer obtained by an additive technique is obtained by screen-printing an ink comprising a carbon-based material.

23. A fabrication method according to claim 22, wherein the ink is an ink comprising graphite.

24. A fabrication method according to claim 16, wherein the catalyst comprises a metal element selected from Ag, Pt, Ru, Ni, Co, Cu, Zn, Au, Ir, Fe, Mn, W, Mo, Pd, In, Rh, Re, Sn, La or mixtures thereof.

25. A fabrication method according to claim 16, further comprising coating the two sides of the ion-exchange membrane with the catalyst to obtain a catalyst-coated ion-exchange membrane; and
wherein the diffusion layer obtained by an additive technique is obtained by screen-printing on at least one side of the catalyst-coated ion-exchange membrane.

26. A fabrication method according to claim 16, wherein the catalyst is coated by spray coating a composition comprising
between 0.1 and 10 wt % of catalyst of the total weight of the composition; and
a solvent or a solvent mixture.

27. A fabrication method according to claim 16, wherein the catalyst is in an amount of between 0.1 and 10 mg/cm².

28. A membrane electrode assembly (MEA) obtainable by the method of fabrication as defined in claim 16, wherein at least one of the diffusion layers has a thickness of below 30 microns.

29. The membrane electrode assembly (MEA) according to claim 28, wherein the ion-exchange membrane has a thickness of below 11 microns.

30. A cell comprising
a compartment comprising
the membrane electrode assembly (MEA) as defined in claim 28, and
means for connecting with a power/load source.

31. The cell according to claim 30, further comprising current collectors comprising metallic particles; wherein the MEA is sandwiched between the current collectors.

32. Method for the electrochemical detection of analytes, which method comprises the use of the membrane electrode assembly (MEA) as defined in claim 28.

33. Method for the electrochemical detection of analytes, which method comprises the use of the cell as defined in claim 30.

34. Method for storing and/or delivering energy, which method comprises the use of the membrane electrode assembly (MEA) as defined in claim 28.

35. Method for storing and/or delivering energy, which method comprises the use of the cell as defined in claim 30.
